(19) United States
(12) Patent Application Publication
(10) Pub. No.: US 2008/0053412 A1
(43) Pub. Date: Mar. 6, 2008

(54) FUEL SUPPLY SYSTEMS

(75) Inventor: Nobuo SUZUKI, Obu-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 11/835,488

(22) Filed: Aug. 8, 2007

(30) Foreign Application Priority Data
Aug. 29, 2006 (JP) 2006-231869
Feb. 7, 2007 (JP) 2007-027688

(51) Int. Cl. F02M 37/08; F04B 49/06

(52) U.S. Cl. 123/497

(57) ABSTRACT

The present invention includes a fuel supply system having a fuel pump constructed to pump fuel from a fuel tank and to supply the fuel, a pump controller constructed to control the fuel pump, and a pump controller case constructed to receive the pump controller. The pump controller case includes a wall portion made of an electrically conductive material, and a portion of the fuel is directed to the wall portion of the pump controller case for cooling the wall portion.

This application claims priority to Japanese patent application serial numbers 2006-231869 and 2007-27688, the contents of which are incorporated herein by reference.

### BACKGROUND OF THE INVENTION

1. Field of the Invention

The present invention relates to fuel supply systems capable of supplying fuel stored within a fuel tank to a vehicle engine.

2. Description of the Related Art

Japanese Laid-Open Patent Publication No. 2001-99029 teaches a fuel supply system as shown in FIG. 9. FIG. 9 shows a front view of a fuel supply system 200, with a part broken away. As shown in FIG. 9, this fuel supply system 200 includes a cover portion 203a and a bracket portion 203B of a mounting member 203, which are resin-molded integrally with a circuit casing 210 that houses a pump controller 212. A metal supply pipe 205 and a metal heat radiator plate 215 are embedded within the cover portion 203A. A fuel pump 206 and a fuel filter 208 are mounted to the bracket portion 203B. The pump controller 212 performs a drive control of the fuel pump 206, so that the fuel is supplied from a discharge pipe 208B of the fuel filter 208 to the supply pipe 205 and further to the exterior of a fuel tank 201. The heat produced by a power transistor 201 that is mounted to a circuit board 213 can be conducted to the supply pipe 205 via the radiator plate 215. The heat can then be dissipated into the fuel that flows through the supply pipe 205.

However, with the fuel supply system 200 disclosed in the above publication, only a part of the radiator plate 215 is connected to the supply pipe 205 for conducting the heat produced by the power transistor 201 that is mounted on the circuit board 213. This type of configuration results in a lack of efficiency in cooling the pump controller 212.

Therefore, there is a need in the art for fuel supply systems that can improve the efficiency of cooling a pump controller.

### SUMMARY OF THE INVENTION

One aspect according to the present invention includes a fuel supply system that includes a fuel pump constructed to pump fuel from a fuel tank and to supply the fuel, a pump controller constructed to control the fuel pump, and a pump controller case constructed to receive the pump controller. The pump controller case includes a wall portion made of an electrically conductive material, and a portion of the fuel is directed to the wall portion of the pump controller case for cooling the wall portion.

Another aspect according to the present invention includes a fuel supply system that includes a fuel pump configured to pump fuel from a fuel tank, a pump controller constructed to control the fuel pump, a pump controller case and a fuel container. The pump controller is positioned inside the pump controller case. The pump controller case includes a wall portion made of an electrically conductive material. The fuel container is positioned adjacent the wall portion of the pump controller case and constructed to store a portion of the fuel.

A further aspect according to the present invention includes a fuel supply system for supplying fuel stored within a fuel tank to a target outside of the fuel tank. The fuel supply system includes a fuel pump disposed within the fuel tank, a pump controller constructed to control the operation of the fuel pump, a pump controller case attached to the fuel tank, wherein the pump controller is disposed within the pump controller case, a first fuel path extending from the fuel pump to the outside target, and a second fuel path extending from the fuel pump to the pump controller case, so that the pump controller case is cooled by the fuel.

### BRIEF DESCRIPTION OF THE DRAWINGS

FIG. 1 is a front view of a fuel supply system according to one embodiment of the present invention;

FIG. 2 is a sectional view taken along line II-II in FIG. 1;

FIG. 3 is a sectional view taken along line III-III in FIG. 1;

FIG. 4 is a plan view of a portion of the system on the side of a reservoir cup:

FIG. 5 is a vertical sectional view of the system and showing a pump controller;

FIG. 6 is a side view showing a mounting structure of a cooling fuel piping to a set plate;

FIG. 7 is an exploded perspective view showing the mounting structure of the cooling fuel piping to the set plate;

FIG. 8 is a vertical sectional view of a fuel pump;

FIG. 9 is a front view with a part broken away of a known fuel supply system;

FIG. 10 is a front view of a fuel supply system according to another embodiment of the present invention;

FIG. 11 is a sectional view taken along line XI-XI in FIG. 10;

FIG. 12 is a sectional view taken along line XII-XII in FIG. 10;

FIG. 13 is a vertical sectional view of the system and showing a pump controller;

FIG. 14 is a plan view of a cooling fuel container according to FIG. 11; and

FIG. 15 is a vertical sectional view of a system according to another embodiment of the present invention.

### DETAILED DESCRIPTION OF THE INVENTION

Each of the additional features and teachings disclosed above and below may be utilized separately or in conjunction with other features and teachings to provide improved fuel supply systems. Representative examples of the present invention, which utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

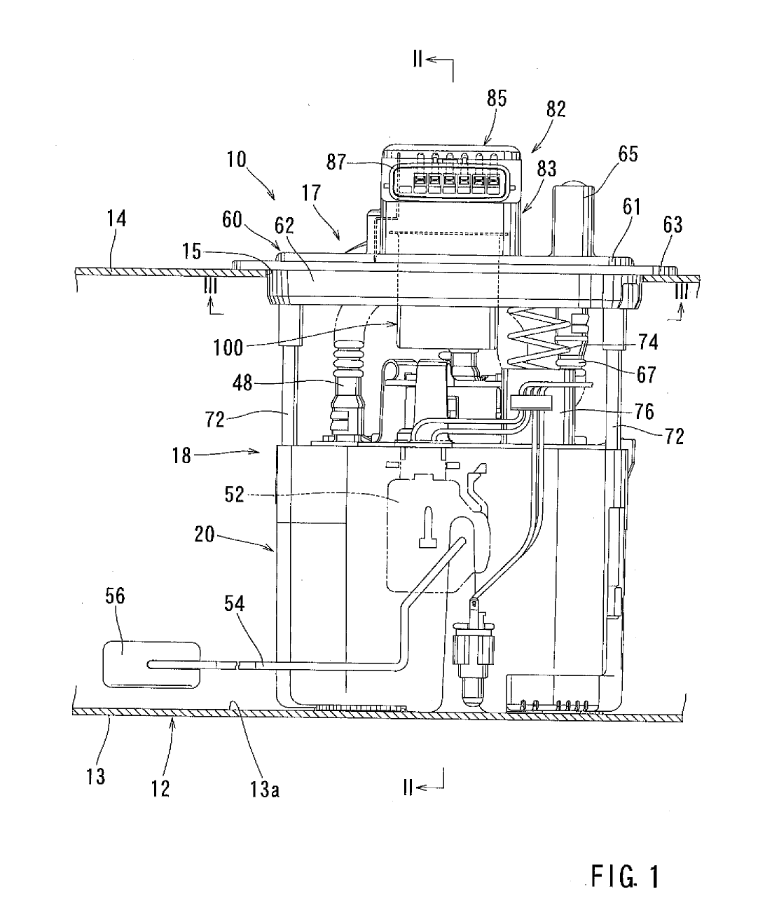

One embodiment according to the present invention will now be described with reference to FIGS. 1 to 8. Referring to FIG. 1, a fuel supply system 10 is assembled with a fuel tank 12 that defines a substantially sealed space for storing the fuel. The fuel tank 12 includes a bottom plate portion 13 and a top plate portion, which extend substantially horizontally, and a side plate portion (not shown). A substantially circular opening 15 is formed in the top plate portion 14.

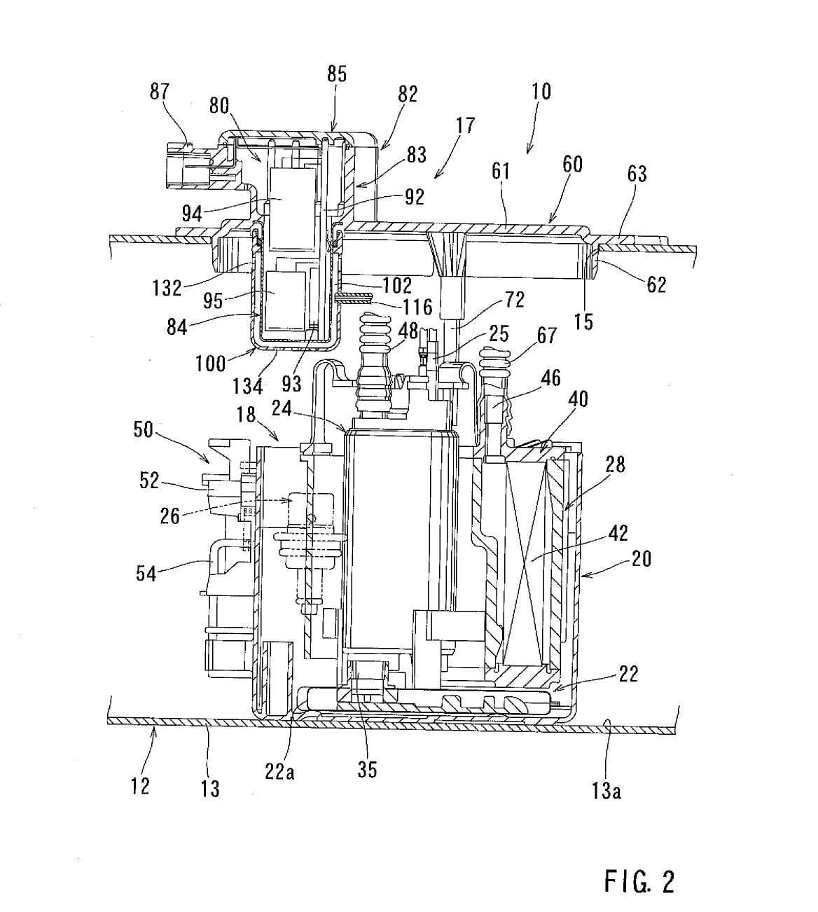

First, the general construction of the fuel supply system 10 will be described. The fuel supply system 10 is configured to supply the fuel within the fuel tank 12 to injectors of a vehicle engine (not shown) or a fuel-consuming target device. The fuel supply system 10 has an upper unit 17 and a lower unit 18. As shown in FIG. 2, the lower unit 18 includes a reservoir cup 20, a first filter (suction filter) 22, a fuel pump 24, a pressure regulator 26 and a second filter 28. The reservoir cup 20 may be made of resin and may have a tubular configuration with an open top and a closed bottom. The reservoir cup 20 is placed on the bottom plate portion 13 of the fuel tank 12. The first filter 22, the fuel pump 24, the pressure regulator 26 and the second filter 28 are disposed within the reservoir cup 20.

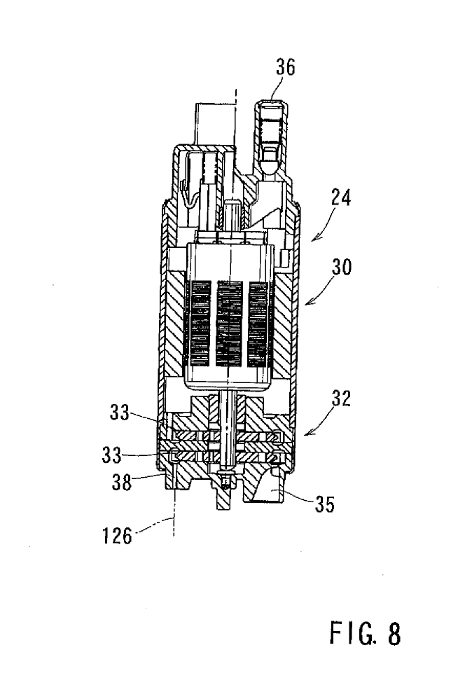

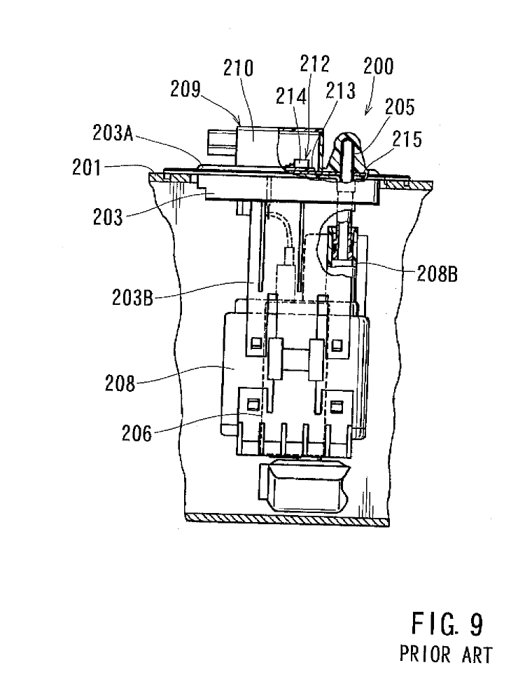

As shown in FIG. 8, the fuel pump 24 is of a motor-integrated type and includes an upper motor section 30 and a lower pump section 32. The upper motor section 30 is configured as an electrically driven motor. The lower pump section 32 is configured as an impeller-type pump. As the motor section 30 is driven, an impeller 33 of the pump section 32 rotates, so that the fuel within the reservoir cup 20 is pumped and pressurized by the pump section 32 and is then discharged from the fuel pump 24. To this end, a suction port 35 is provided on the lower side of the fuel pump 24, and a discharge port 36 is provided on the upper side of the fuel pump 24. Also, a vapor jet 38 is provided on the lower side of the fuel pump 24 in order to discharge the vapor that may be contained in the fuel during the pressurization process. The fuel that is discharged from the vapor jet 38 will be hereinafter also called “discharged fuel with vapor.”

As shown in FIG. 2, the first filter (suction filter) 22 is attached to the suction port 35 of the fuel pump 24. For example, the first filter 22 may include a filter bag 22a that is made of resin and filtrates the fuel as the fuel is pumped from the reservoir cup 20 into the fuel pump 24.

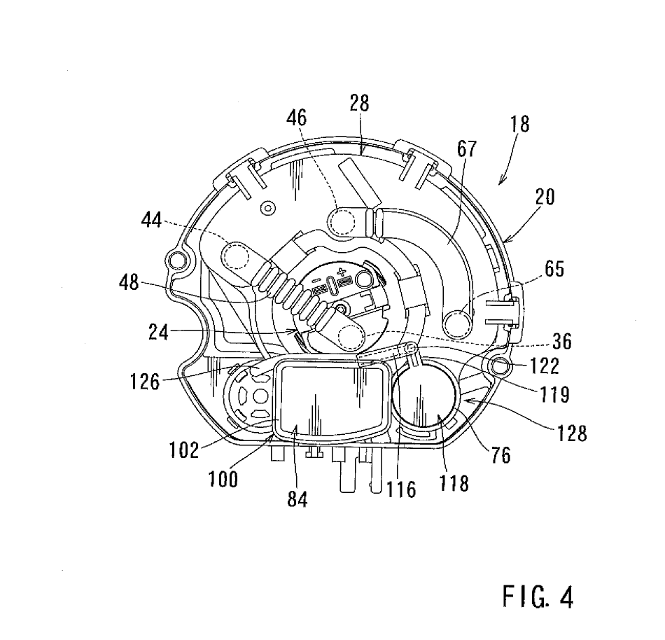

As shown in FIG. 4, the second filter 28 has a substantially C-shape configuration and surrounds the circumference of the fuel pump 24. The second filter 28 includes a filter casing 40 and a filter element 42 received within the filter casing 40 (see FIG. 2). A fuel inlet 44 and a fuel outlet 46 are provided on the filter casing 40 (see FIG. 4). One end of a first piping member 48 is connected to the fuel inlet 44 and the other end of the first piping member 48 is connected to the discharge port 36 of the fuel pump 24. Therefore, the fuel may flow out of the fuel pump 24 into the second filter 28 via the first piping member 48 so as to be filtered by the filter element 42. The fuel may then flow out of the fuel outlet 46 (see FIG. 2). The first piping member 48 may be a bellows-like tube made of nylon.

The pressure regulator 26 (see FIG. 2) is assembled to the second filter 28. When the pressure of the fuel flowing out of the fuel outlet 46 of the second filter 28 or the pressure of the fuel flowing out of the fuel tank 12 exceeds a predetermined value, the pressure regulator 26 returns a part of the fuel into the reservoir cup 20 in order to adjust the fuel pressure to the predetermined value. The fuel that is returned from a fuel returning port (not shown) of the pressure regulator 26 into the fuel tank 12 (i.e., into the reservoir cup 20) will be hereinafter also called “discharged return fuel.”

A sender gauge 50 is disposed on a front side of the reservoir cup 20 (see FIG. 2). The sender gauge 50 serves as a liquid-level meter and detects the liquid level or the fuel level within the fuel tank 12 based on the electric resistance. The detected fuel level is indicative of the amount of fuel within the fuel tank. The sender gauge 50 includes a gauge body 52, a swing arm 24 and a float 56. The gauge body 52 is mounted to the reservoir cup 20 by a snap-fit mechanism. The swing arm 54 is pivotally mounted to the gauge body 52. The float 56 is attached to the free end of the swing arm 54 and floats on the surface of the liquid or the fuel within the fuel tank 12 (see FIG. 1).

The upper unit 17 will now be described. As shown in FIG. 2, the upper unit 17 has a set plate 60, which can be made of resin, as a primary element. The set plate 60 has a disk-like plate body 61, a cylindrical fitting sleeve 62 and a flange 63. The plate body 61 closes the opening 15 of the fuel tank 12. The fitting sleeve 62 is fitted into the opening 15. The flange 63 extends from the outer periphery of the plate body 61 for engaging and holding the upper side of the peripheral edge of the opening 15. The opening 15 may be sealingly closed by fitting the set plate 60 such that the flange 63 is held against the top plate portion 14 of the fuel tank 12 with a gasket (not shown) interleaved therebetween. In this way, the set plate 60 serves as a cover or a closure member.

As shown in FIG. 1, a fuel discharge pipe 65 is formed with the plate body 61 and extends upward and downward therefrom to define a flow channel extending vertically through the plate body 61. A portion of the fuel discharge pipe 65 positioned on the lower side of the plate body 61 is connected to one end of a second piping member 67. Opposite end of the second piping member 67 is connected to the fuel outlet 46 of the second filter 28 (see FIG. 2). The second piping member 67 may be a bellows-like tube made of nylon.

A fuel supply line (not show) is connected to a portion of the fuel discharge pipe 65 positioned on the upper side of the plate body 61. The fuel supply line is in communication with a fuel delivery pipe that has injectors (not shown). Therefore, the fuel filtered by the second filter 28 is delivered under pressure to the fuel supply line on the outside of the fuel tank 12 via the second piping member 67 and the fuel discharge pipe 65. The fuel is further delivered to the injectors from the fuel supply line via the fuel delivery pipe and is injected into combustion chambers of the engine. For the purpose of explanation, the fuel that is delivered from the fuel supply system 10 to the outside of the fuel tank 12 will be herein after called “primary fuel stream.”

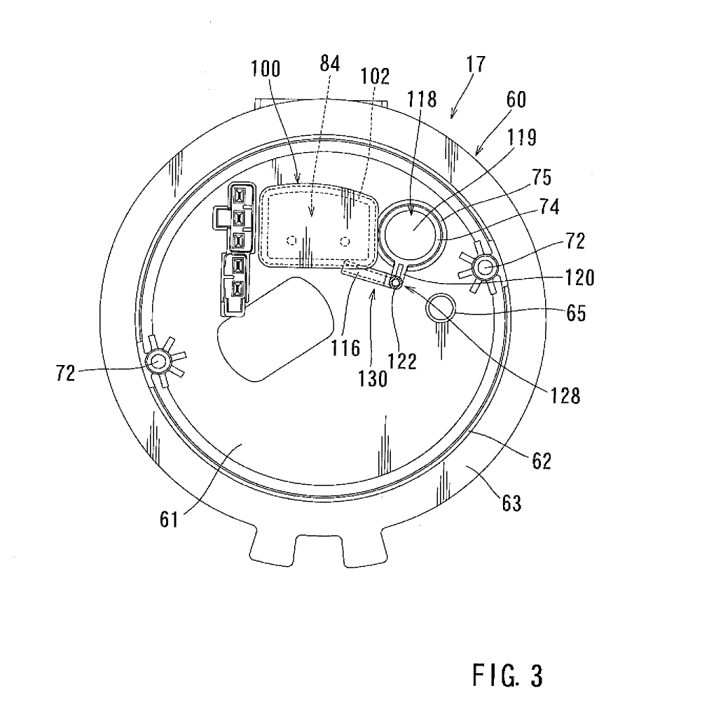

As shown in FIG. 1, a pair of guide rails 72 are supported within the fitting sleeve 62 of the set plate 60 and extend downwardly therefrom. Each of the guide rails 72 is vertically movably coupled to the reservoir cup 20. A spring 74 that is a coil spring in this embodiment is interleaved in a compressed state between the upper unit 17 and the lower unit 18. More specifically, the upper end of the spring 74 is fitted into an upper spring guide 75 that extends downward from the plate body 61 of the set plate 60 (see FIG. 3). The upper spring guide 75 has a cylindrical tubular configuration and has a closed upper end and an open lower end. The lower end of the spring 74 is fitted into a lower spring guide 76 that is disposed on the upper end of the lower unit 18, such as an upper end of the filter casing 40 of the second filter 28 (see FIG. 4). The lower spring guide 76 has a cylindrical tubular configuration and has an open upper end and a closed lower end. Due to the resilient force applied by the spring 74, the lower unit 18 or the reservoir cup 20 is pressed against the bottom plate portion 13, more specifically, against a bottom surface 13a of the bottom plate 13 on the side of the interior of the fuel tank 12. Therefore, if the vertical position of the lower unit 18 within the fuel tank 12 has been changed due to change of pressure within the fuel tank 12 in response to the amount of fuel stored within the fuel tank 12 or the environmental temperature, the lower unit 18 can move vertically relative to the upper unit 17, while the reservoir cup 20 is kept to contact with the bottom surface 13a by the biasing force of the spring 74.

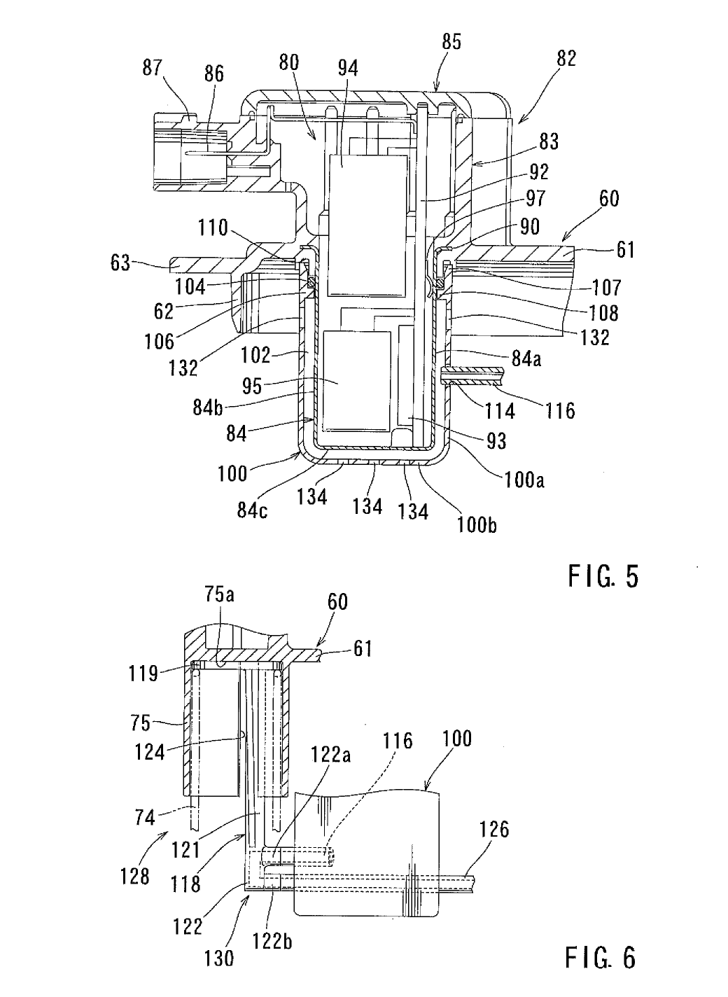

As shown in FIG. 2, a box-shaped pump controller case 82 is provided on the set plate 60 of the fuel supply system 10 in order to house a pump controller 80 that controls the fuel pump 24. As shown in FIG. 5, the controller case 82 has a case body 83, a housing 84 and a cover 85 respectively constituting a first body, a second body and a third body of the controller case 82. The housing 84 is disposed on the lower side of the case body 83. The cover 85 is disposed on the upper side of the case body 83.

The case body 83 can be made of resin and formed integrally with the plate body 61 of the set plate 60. The case body 83, which can have a hollow tubular configuration and a lower end connected to the plate body 61. An electrical connector portion 87 is formed with the case body 83 and has terminals 86 extending therethrough. An electrical connector portion 25 of the fuel pump 24 is electrically connected to the electrical connector portion 87. Within the controller case 82, the terminals 86 are electrically connected to a circuit board 92 (that will be explained later) of the pump controller 80. Although not shown in the drawings, an external connector connects an electronic control unit (ECU) to the electrical connector portion 87.

The housing 84 is made of electrically conductive metal, in particular a metal having a high electrical conductivity. The housing 84 has an open top and a closed bottom. Therefore, the housing 84 may serve as an electrically conductive wall. The housing 84 has a side wall 84a, which can have a prismatic tubular configuration, and a bottom wall 84c. An outwardly extending flange 90 is formed on the upper end of the side wall 84a of the housing 84. The flange 90 is integrated with the lower end of the case body 83 by an insertion molding process. The cover 85 is made of resin and is joined to the upper end of the case body 83 by welding, for example, by hot-plate welding.

As shown in FIG. 5, the pump controller 80 disposed within the controller case 82 includes the circuit board 92 as well as an IC chip 93, a choke coil 94 and a capacitor 95, etc., that are mounted to the left side surface (hereinafter also called “mounting surface”) of the circuit board 92. The circuit board 92 is positioned to extend vertically within the controller case 82 from the bottom of inner space of the housing 84 to the lower surface of the cover 85. The right side surface (opposite to the mounting surface) of the circuit board 92 is positioned adjacent to the inner surface of the side wall 84a of the housing 84. The IC chip 93 is mounted to the lower portion of the mounting surface of the circuit board 92 so as to be positioned at a lower region within the housing 84. The IC chip 93 is configured to operate based on an output signal from the ECU in order to perform a variable control of the voltage applied to the motor section 30 of the fuel pump 24 and to eventually drive the fuel pump 24.

The choke coil 94 is mounted to the upper portion of the mounting surface of the circuit board 92 and is positioned within the case body 83. Terminals of the capacitor 95 can be mounted to the mounting surface of the circuit board 92 in positions between the IC chip 93 and the choke coil 94. The capacitor 95 can be positioned within a space defined between the IC chip 93 and a side wall 84b of the housing 84 opposing to the IC chip 93. The choke coil 94 and the capacitor 95 constitute a filtration circuit for absorbing or eliminating noises that may be produced when the IC chip 93 is activated.

A ground terminal 97 is mounted to the surface opposite to the mounting surface and resiliently and electrically contacts the upper portion of the inner wall of the housing 84. A thermal conductive member (not shown) made of material having a good thermal conductivity is disposed between the circuit board 92 and the housing 84. Therefore, the heat that may be produced by the activation of the IC chip 93, in particular the activation of a switching element of the IC chip 93, can be effectively conducted to the housing 84 via the thermal conductive member. The present invention can also be configured to omit the thermal conductive member.

A cooling fuel container 100 is disposed on the lower side of the case body 83 and surrounds or encloses the entire housing 84, while the cooling fuel container 100 is spaced from the housing 84 by a predetermined gap. The cooling fuel container 100 may be made of resin or metal. The cooling fuel container 100 has a tubular configuration with an open top and a closed bottom and includes a side wall 100a and a bottom wall 100b for closing the open bottom of the side wall 100a. The side wall 100a has a prismatic tubular configuration similar to the side wall 84a of the housing 84. The cooling fuel container 100 may be attached to the lower side of the set plate 60 by hot-plate welding, via a snap-fit mechanism, or any other suitable means. In this way, a cooling fuel storage chamber 102 having a bottomed tubular configuration is defined between the housing 84 and the cooling fuel container 100 to face the housing 84 in order to allow the fuel to contact the housing 84.

An O-ring 104 is attached by using the cooling fuel container 100 and prevents the fuel from flowing into the controller case 82 via a potential clearance that may be produced between the set plate 60 and the housing 84 due to difference in the linear expansion coefficient between the set plate 60 and the housing 84. Thus, a retainer portion 106 is formed integrally with the upper end of the side wall 100a of the cooling fuel container 100 and includes an upwardly extending tubular part 107 and an annular projection 108 extending inwardly from the base end (lower end) of the tubular part 107. In addition, an annular fitting recess 110 is formed in the lower end of the case body 83 in such a manner that the annular fitting recess 110 surrounds the housing 84 while being spaced from the housing 84 in the radial direction. In order to mount the fuel container 100 to the case body 83, the O-ring 104 is fitted onto the housing 84 and is moved to a position adjacent to the lower end of the case body 83. In this state, the tubular part 107 of the retainer portion 106 of the cooling fuel container 100 is fitted into the fitting recess 110 of the case body 83, so that the O-ring 104 can be sealingly clamped or held within an annular space formed on the inner circumferential side of the retainer portion 106 and between the annular projection 108 and the lower end of the case body 83 opposing thereto in the vertical direction. In this way, the O-ring 104 can prevent the fuel from entering a potential clearance that may be produced between the set plate 60 and the housing 84 due to the difference in their linear expansion coefficients. Hence, it is possible to prevent the fuel from flowing into the interior of the controller case 82.

Alternatively, the O-ring 104 may be held in position by a retaining member (not shown) that is a separate member from the cooling fuel container 100 and corresponds to the retainer portion 106 of the fuel container 100. The retainer member may be attached to the lower end of the set plate 60 by welding or by adhesive. Nevertheless, without use of the O-ring 104, it is possible to seal a potential clearance that may be formed between the set plate 60 and the housing 84 due to the difference in their linear expansion coefficients. Thus, a sealing agent may be applied to the flange portion 90 of the housing 84, which is to be covered by the resin material of the set plate 60, and the set plate 60 may be then molded by resin while the housing 84 is inserted into a mold.

A nozzle mounting hole 114 is formed in the side wall 10a of the fuel container 100 opposing to the side wall 84a of the housing 84, which is positioned proximate to the IC chip 93 of the pump controller 80. The front end of a cooling fuel supply nozzle 116 is substantially closely fitted into the nozzle mounting hole 114. A nozzle holder 118 that will be explained later supports the based end or the rear end of the nozzle 116.

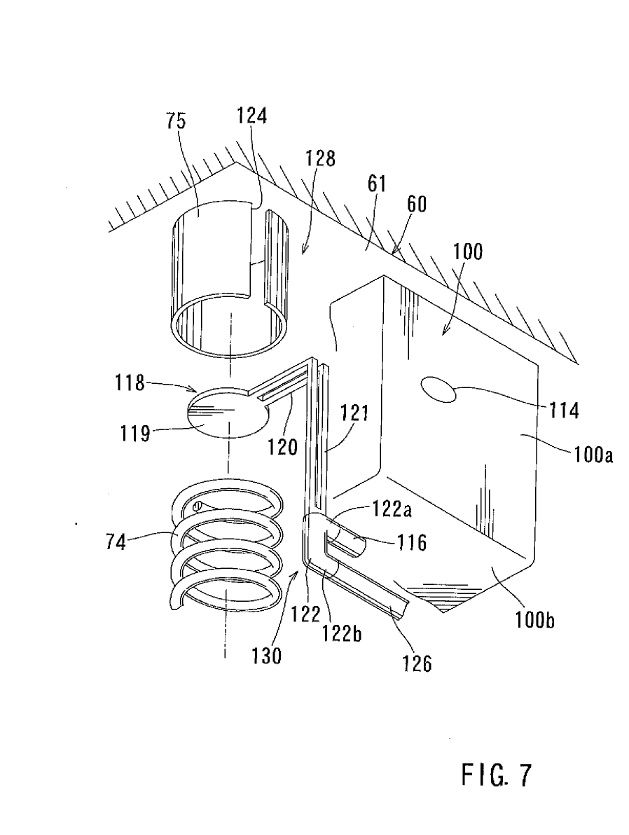

As shown in FIG. 7, the nozzle holder 118 can have a circular disk-like engaging portion 119, a rotation preventing portion 120, an arm portion 121 and a connecting tube 122. The rotation preventing portion 120 extends radially outward from the engaging portion 119. The arm portion 121 extends vertically downward from the front end (radially outer end) of the rotation preventing portion 120. The connecting tube 122 is disposed at the front end (lower end) of the arm portion 121. The engaging portion 119 is configured so as to engage within or fit into the spring guide 75 of the set plate 60. The rotation preventing portion 120 is configured to engage a rotation preventing slot 124 formed in the spring guide 75 of the set plate 60. The rotation preventing slot 124 is positioned proximally to the base end of the nozzle 116 as viewed in a plan view and extends like a split from the bottom end to the top end of the spring guide 75, which is defined by the bottom surface of the set plate 60. The connecting tube 122 has a U-shape configuration and has a pair of connecting ends 122a and 122b that are open laterally in a horizontal direction. The base end of the nozzle 116 is joined to the connecting end 122a of the connecting tube 122, which is positioned on the upper side as viewed in FIG. 7. Alternatively, the connecting tube 122 may be formed integrally with the nozzle 116. A first end of a cooling fuel tube 126 is joined to the connecting end 122b of the connecting tube 122, which is positioned on the lower side as viewed in FIG. 7. A second end opposite to the first end of the cooling fuel tube 126 is joined to a suitable fuel discharge port, from which the cooling fuel is discharged. In this embodiment, the fuel that contains the vapor and discharged from the fuel pump 23 is used as the cooling fuel. Therefore, the second end of the cooling fuel tube 126 is joined to the vapor jet 38 of the fuel pump 24.

The nozzle holder 118 can be assembled to the set plate 60 as will be hereinafter described. Prior to fitting the spring 74 into the spring guide 75 of the set plate 60, the engaging portion 119 is fitted into the spring guide 75 and the rotation preventing portion 120 is engage with the rotation preventing slot 124. Then, the upper end of the spring 74 is fitted into the spring guide 75, so that the engaging portion 119 is resiliently held between a bottom surface 75a (see FIG. 6) of the spring guide 75 and the upper end of the spring 74. The engaging portion 119 can be prevented from rotating relative to the spring guide 75 through engagement of the rotation preventing portion 120 with the rotation preventing slot 124. Therefore, the nozzle holder 118 can be readily mounted to the set plate 60 without need of specific fixing means, such as screws and a crimping device. In this embodiment, the engaging portion 119 and the rotation preventing portion 120 of the nozzle holder 228, the spring guide 75 having the rotation preventing slot 124, and the spring 74 constitute an attaching mechanism or an engaging mechanism 128. The cooling fuel supply nozzle 116, the connecting tube 122 and the cooling fuel tube 126 constitute a cooling fuel piping 130.

If the primary fuel stream towards the outside of the fuel tank 12 is used as a cooling fuel, the second end of the cooling fuel tube 126 may be joined to a fuel discharge port provided on a primary fuel piping (not shown) for the primary fuel stream. For example, the primary fuel piping may be the fuel discharge pipe 65 of the set plate 60. Alternatively, if a stream of the fuel that is returned from the pressure regulator 26 to the fuel tank 12 (hereinafter called “return fuel stream” is used as a cooling fuel, the second end of the cooling fuel tube 126 may be joined to a return fuel discharge port (not shown) of the pressure regulator 26. In this way, at least one of the stream of the fuel discharged with vapor (hereinafter called “fuel and vapor stream”, the primary fuel stream and the return fuel stream may be used for the cooling fuel. If two of the fuel and vapor stream, the primary fuel stream and the return fuel stream are used for the cooling fuel, the cooling fuel tube 126 may be branched for connecting with corresponding discharge ports of the two fuel streams. Otherwise, the connecting tube 122 may be branched and connected to second ends of a plurality of cooling fuel tubes 126.

As shown in FIG. 5, a suitable number of cooling fuel discharge holes 132 (two discharge holes 132 are shown in FIG. 5) are formed in the upper end portion of the side wall 100a of the fuel container 100 or a portion of the side wall 100a beneath the retainer portion 106. The discharge holes 132 should be positioned at a higher level than the nozzle mounting hole 114.

A suitable number of cooling fuel release holes 134 (three release holes 134 are shown in FIG. 5) are formed in the bottom wall 100b of the fuel container 100. The open area of the release holes 134 is determined such that the amount of the cooling fuel flowing out of the release holes 134 is equal to or smaller than the amount of the cooling fuel that is supplied into the fuel storage chamber 102.

With the fuel supply system 10 described above, the fuel and vapor stream or the cooling fuel discharged from the vapor jet 38 of the fuel pump 24 is delivered to the fuel supply nozzle 116 via the cooling fuel tube 126 and the connecting tube 122. The cooling fuel is then discharged from the fuel supply nozzle 116 in a direction towards the side wall 84a of the housing 84. In other words, the fuel supply nozzle 116 is oriented such that the fuel impinges onto the side wall 84a. Therefore, the cooling fuel impinging onto the side wall 84a may cool the side wall 84a. Further, the cooling fuel may then be stored within the cooling fuel storage chamber 102 of the cooling fuel container 100, so that the entire housing 84 can be cooled. Subsequently, the cooling fuel may overflow from the cooling fuel storage chamber 102 and may then be discharged from the cooling fuel discharge holes 132 of the side wall 100a of the cooling fuel container 100. The discharged cooling fuel thereafter flows into the fuel tank 12 or the reservoir cup 20. In addition, a part of the cooling fuel stored within the fuel storage chamber 102 may be discharged from the release holes 134 formed in the bottom wall 13 of the fuel container 100 and may then also flow into the fuel tank 12 or the reservoir cup 20.

According to the fuel supply system 10 described above, the cooling fuel is supplied into the housing 84 of the controller case 82 such that the cooling fuel is discharged towards the side wall 84a of the housing 84 proximate to the IC chip 93 that is a heat generating source. Therefore, the cooling fuel may contact the housing 84, in particular the side wall 84a, so that the effect of cooling the housing 84 can be increased and the efficiency of cooling the pump controller 80 can be improved.

In addition, the cooling fuel storage chamber 102 facing to the housing 84 of the controller case 82 and allowing the cooling fuel to contact with the housing 84 is provided for receiving the supply of the cooling fuel. Therefore, the effect of cooling the housing 84 can be further increased and the efficiency of cooling the pump controller 80 can be further improved.

Further, because the cooling fuel is discharged from the discharge holes 132 that are positioned at a higher level than the cooling fuel supply nozzle 116, from which the cooling fuel is supplied into the cooling fuel storage chamber 102. Therefore, the cooling fuel stored within the cooling fuel storage chamber 102 can be effectively used for cooling the housing 84.

Furthermore, because the cooling fuel is discharged from the release holes 134 communicating with a lower portion of the cooling fuel storage chamber 102, it is possible to prevent or minimize the retention of the cooling fuel within the cooling fuel storage chamber 102. Therefore, it is possible to prevent or minimize rotting of the retained cooling fuel and to eventually prevent or minimize the erosion of the housing 84.

Furthermore, the fuel with vapor discharged from the fuel pump 24 (fuel and vapor stream) can be used for the cooling fuel.

Furthermore, the cooling fuel piping 130 for supplying the cooling fuel is attached to the set plate 60, which has the controller case 82, via the attaching or engaging mechanism 128. Therefore, the set plate 60 can readily hold the cooling fuel piping 130. In addition, even if the height of the set plate 60 has been changed relative to the fuel tank 12 due to change in pressure within the fuel tank 12, the position of the cooling fuel supply nozzle 116 relative to the set plate 60 may not change. Therefore, it is possible to always supply the fuel to a target point within the housing 64 by the supply nozzle 116.

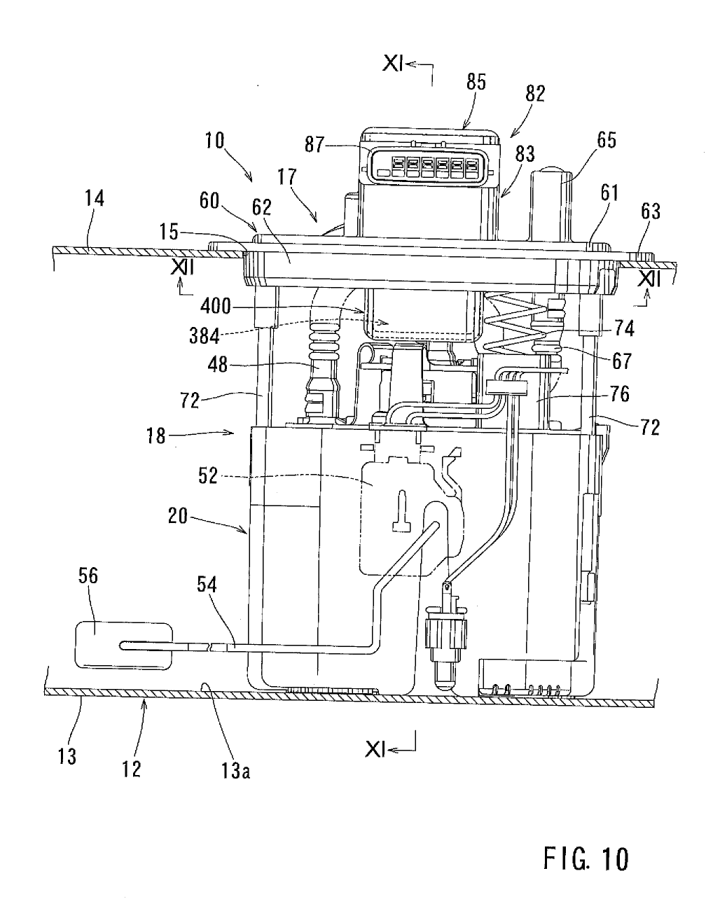

Another embodiment will now be described with reference to FIGS. 10 to 14. This embodiment is a modification of the previous embodiment and is different from the first embodiment in the configuration of the housing 84 of the controller case 82 and the cooling fuel container 100. Therefore, in FIGS. 10 to 14, like members are given the same reference numerals as the previous embodiment and the description of these elements will not be repeated.

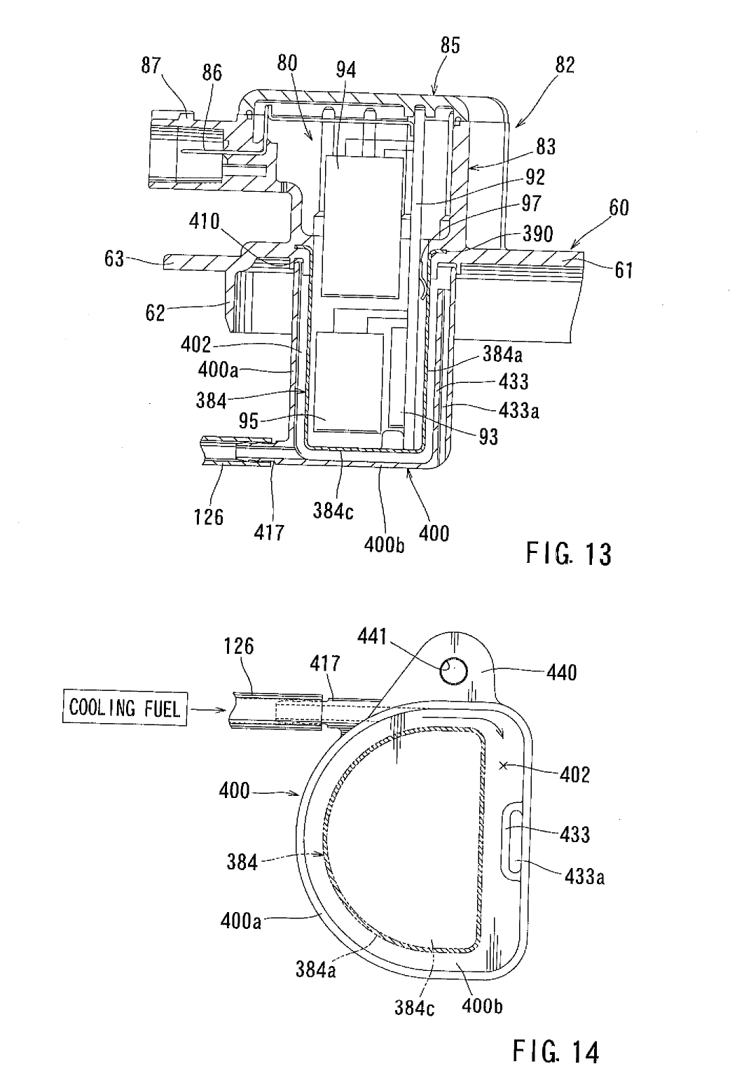

Referring to FIG. 13, a housing 384 corresponding to the housing 84 of the first embodiment (see FIG. 5) is similar to the housing 84 in that the housing 384 is made of electrically conductive metal, in particular a metal having a high electrically conductivity. In addition, the housing 384 has an open top and a closed bottom. However, the housing 384 has a tubular side wall 384 having a substantially D-shaped configuration in plan view (see FIG. 14) and a bottom wall 384c. As shown in FIG. 14, the corner portions of the D-shape of the side wall 384 are rounded, so that the side wall 384 gently continues in the circumferential direction like a D-shape loop. An outwardly extending flange 390 is formed on the upper end of the side wall 384a of the housing 384 (see FIG. 13). The flange 390 is integrated with the lower end of the case body 83 by an insert molding process, so that the lower opening of the case body 83 is integrated into the housing 384.

As shown in FIG. 3, a cooling fuel container 400 is disposed on the lower side of the case body 83 and surrounds or encloses the entire housing 384, while the cooling fuel container 400 is spaced from the housing 384 by a predetermined gap. Similar to the cooling fuel container 100 of the first embodiment, the cooling fuel container 400 may be made of resin or metal. The cooling fuel container 400 can have a tubular configuration with an open top and a closed bottom and includes a side wall 400a and a bottom wall 400b. The side wall 400a has a D-shaped configuration in plan view similar to the side wall 384a of the housing 384 (see FIG. 14). Thus, similar to the side wall 384a, the corner portions of the D-shape of the side wall 400a are rounded, so that the side wall 400a gently continues in the circumferential direction like a D-shape loop.

A mounting piece 440 is formed integrally with the upper portion of the side wall 400a of the cooling fuel container 400 and extends radially outward (upward as viewed in FIG. 14) therefrom. As shown in FIG. 13, a mount hole 441 is formed in the mounting piece 440 and extends therethrough in the vertical direction (in the direction perpendicular to the sheet of FIG. 14).

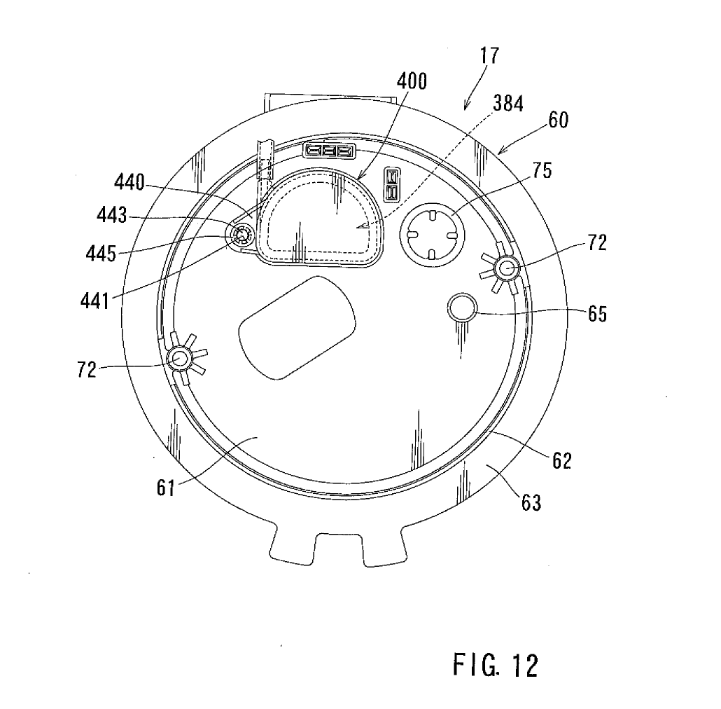

A mounting rod 443 extends from the lower end of the plate body 61 of the set plate 60 and is inserted into the mounting hole 441 (see FIG. 12).

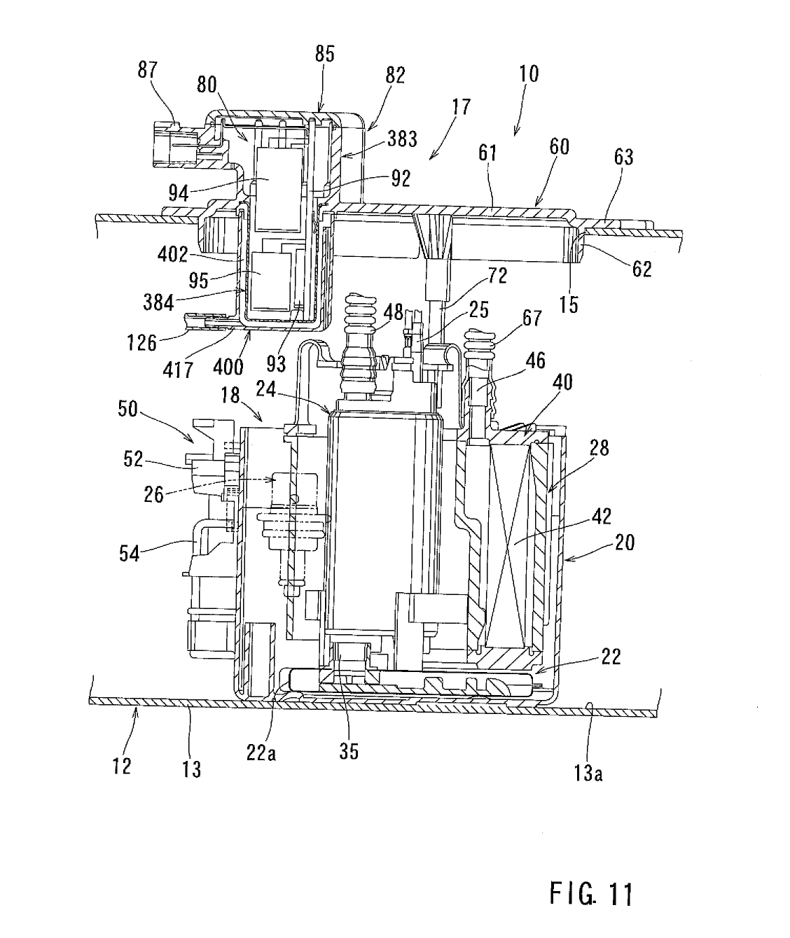

The cooling fuel container 400 may be attached to the set plate 60 as will be hereinafter described. First, as shown in FIG. 12, the mounting rod 443 of the plate body 61 of the set plate 60 is inserted into the mounting hole 441 of the mounting piece 440. Thereafter, a snap ring 445 is fitted onto the mounting rod 443, so that the mounting piece 440 can be prevented from being removed from the mounting rod 443. Hence, the cooling fuel container 400 can be readily attached to the set plate 60 so as to be positioned on the lower side of the case body 83 of the controller case 82 (see FIG. 11). In this way, a cooling fuel storage chamber 402 having a bottomed tubular configuration is defined between the housing 384 and the cooling fuel container 400 to face the housing 384 in order to allow the fuel to contact the housing 384 (see FIGS. 13 and 14).

In this embodiment, a potential clearance that may be formed between the set plate 60 and the housing 384 due to the difference in their linear expansion coefficients is prevented by the following construction. Thus, a sealing agent may be applied to the flange portion 390 of the housing 384, which is to be covered by the resin material of the set plate 60, and the set plate 60 may be then molded by resin, while the housing 384 is inserted into a mold. Therefore, the O-ring 104 of the previous embodiment (see FIG. 5) can be omitted. An annular fitting recess 410 is formed in the lower end of the case body 83 in such a manner that the fitting recess 410 surrounds the housing 384 while being spaced from the housing 384 in the radial direction. The upper end of the side wall 400a of the cooling fuel container 400 is in engagement with the fitting recess 410.

A cooling fuel supply pipe 417 is formed integrally with the lower end portion of the side wall 400a of the cooling fuel container 400 and extends laterally (horizontally) outward (leftward as viewed in FIG. 13) therefrom. More specifically, the supply pipe 417 extends from one side of the side wall 400a (upper side as viewed in FIG. 14) tangentially (leftward as viewed in FIG. 14) with respect to the cooling fuel storage chamber 402. The cooling fuel supply pipe 417 is joined to the first end of the cooling fuel tube 126.

As shown in FIG. 13, a cooling fuel discharge pipe 433 is formed integrally with the flat inner wall surface of the side wall 400a of the cooling fuel container 400. In other words, the discharge pipe 433 is formed by using the side wall 400a as a part of the discharge pipe 433. The discharge pipe 433 has an oblong configuration in cross section as shown n FIG. 14 and defines a cooling fuel discharge channel 433a therein. The upper end of the discharge channel 433a is opened at a level slightly lower than the upper end of the side wall 400a. On the other hand, the lower end of the discharge channel 433a is positioned at a lower level than the upper surface of the bottom wall 400b.

In this embodiment, the nozzle mounting hole 114, the cooling fuel supply nozzle 116, the nozzle holder 118 and the engaging mechanism 128 as provided in the previous embodiment are omitted. A suitable number of fuel release holes similar to the fuel release holes 134 of the previous embodiment may be formed in the lower portion of the cooling fuel container 400 in order to prevent or minimize rotting of the retained cooling fuel and to eventually prevent or minimize the erosion of the housing 384.

With the fuel supply system 10 of the this embodiment, the fuel with vapor or the cooling fuel discharged from the vapor jet 38 of the fuel pump 24 (see FIG. 8) is delivered to the fuel supply pipe 417 of the cooling fuel container 400 via the cooling fuel tube 126, and the cooling fuel is then discharged from the fuel supply pipe 417 into the cooling fuel storage chamber 402 as indicated by arrows in FIG. 14. Therefore, the cooling fuel may cool the side wall 384a. Further, the cooling fuel stored within the fuel storage chamber 402 of the cooling fuel container 400 cools the entire housing 384. Subsequently, the cooling fuel may overflow from the cooling fuel storage chamber 402 and may then be discharged from the cooling fuel discharge channel 433a of the discharge pipe 433 of the cooling fuel container 400. The discharged cooling fuel thereafter flows into the fuel tank 12 or the reservoir cup 20.

Also, with the this embodiment, similar effects and advantages as the previous embodiment can be achieved. In addition, in this embodiment, the cooling fuel is discharged via the discharge channel 433a defined in the discharge pipe 433 and the upper opening of the discharge channel 433a is positioned at level higher than the cooling fuel supply pipe 417 that supplies the cooling fuel to the cooling fuel storage chamber 402 (see FIG. 13). Therefore, it is possible to effectively cool the housing 384 by the fuel supplied into the cooling fuel storage chamber 402.

In addition, in this embodiment, the cooling fuel is discharged into the cooling fuel storage chamber 402 from the cooling fuel tube 126 via the cooling fuel supply pipe 417 of the cooling fuel container 100 (see arrows in FIG. 14). Therefore, the supplied cooling fuel can flow along the inner wall surfaces of the cooling fuel storage chamber 402, i.e., the outer circumferential surface of the side wall 384a of the hosing 384 and the inner circumferential surface of the side wall 400a of the cooling fuel container 400. Hence, the cooling fuel can smoothly flow along the inner wall surfaces of the cooling fuel storage chamber 402. As a result, it is possible to effectively cool the housing 384 and to reduce potential sounds that may be produced when the cooling fuel impinges on the outer circumferential surface of the side wall 384a of the housing 384 and the inner circumferential surface of the side wall 400a of the cooling fuel container 400. Eventually, it is possible to improve the silent characteristic of the fuel supply system 10. It may be possible to configure such that the cooling fuel flows along either one of the outer circumferential surface of the side wall 384a of the housing 384 and the inner circumferential surface of the side wall 400a of the cooling fuel container 400.

Further, the corners of the D-shapes of the side wall 384a of the housing 384 and the side wall 400a of the cooling fuel container 400 are rounded, so that side walls 384a and 400a gently continue in the circumferential direction. Therefore, the cooling fuel can smoothly circulate within the cooling fuel storage chamber 402 (see FIG. 14). As a result, it is possible to reduce the impinging force of the cooling fuel on the outer circumferential surface of the side wall 384a of the housing 384 and the inner circumferential surface of the side wall 400a of the cooling fuel container 400, which defines the inner wall surfaces of the cooling fuel storage chamber 402. This can reduce the sounds that may be produced as the cooling fuel flows within the cooling fuel storage chamber 402. Therefore, this configuration aids in the production of a more silent fuel supply system 10.

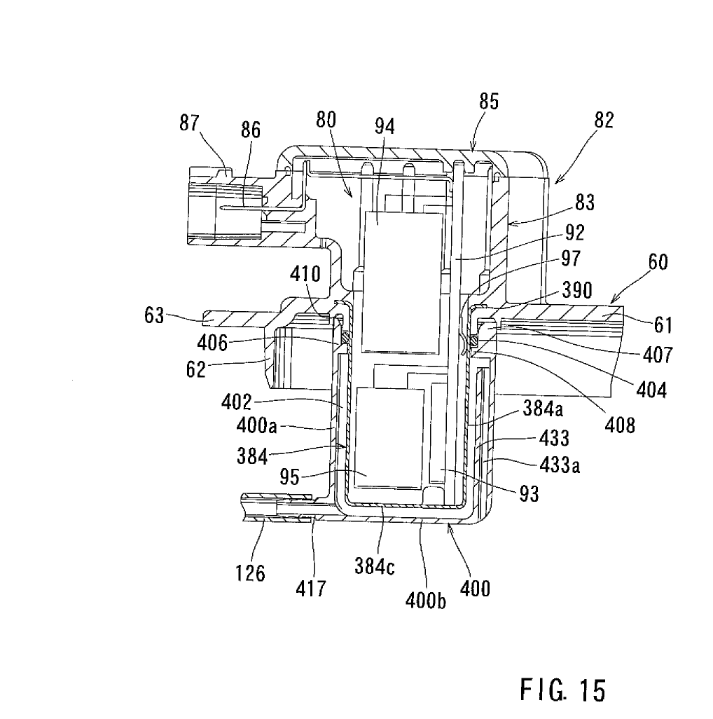

Another embodiment, similar to that shown in FIGS. 11-14 will now be shown. The structure for preventing the fuel from flowing into the controller case 82 via a clearance that may be produced between the set plate 60 and the housing 384 due to difference in the linear expansion coefficient between the set plate 60 and the housing 384 may be modified as shown in FIG. 15. The arrangement shown in FIG. 15 is similar to the arrangement of the previous embodiments. Thus, a retainer portion 406 is formed integrally with the upper end of the side wall 400a of the cooling fuel container 400 and includes an upwardly extending tubular part 407 and an annular projection 408 extending inwardly from the base end (lower end) of the tubular part 107. In order to mount the cooling fuel container 400 to the case body 83, an O-ring 404 is fitted onto the housing 384 and is moved to a position adjacent to the lower end of the case body 83. In this state, the tubular part 407 of the retainer portion 406 of the cooling fuel container 400 is fitted into a fitting recess 410 formed in the case body 83, so that the O-ring 404 can be sealingly clamped or held within an annular space formed on the inner circumferential side of the retainer portion 406 and between the annular projection 408 and the lower end of the case body 83 opposing thereto in the vertical direction. The O-ring 404 can prevent the fuel from entering a potential clearance that may be formed between the set plate 60 and the housing 384 due to the difference in their linear expansion coefficients. Hence, it is possible to prevent the fuel from flowing into the interior of the controller case 82. The O-ring 404 may be held in position by forming the retainer portion 406 of the cooling fuel container 400 as a retainer member that is a separate member from the cooling fuel container 400. The retainer member may be attached to the lower end of the set plate 60 by welding or by adhesive.

The present invention may not be limited to the above embodiments but may be modified in various ways without departing from the spirits of the invention. For example, the cooling fuel may be supplied to flow towards the bottom wall 84c(384c) of the housing 38(384) of the controller case 82, instead of supplying the cooling fuel towards the side wall 84a(384a). In addition, the cooling fuel may be supplied from a plural number of positions of the housing 38(384c) of the controller case 82. In addition, because the efficiency of cooling the pump controller 80 can be improved even by simply supplying the cooling fuel towards the housing 38 (384) of the controller case 82, the cooling fuel container 100(400) can be omitted in certain configurations. Further, although the cooling fuel container 100(400) surrounds or encloses the entire housing 38(384), the cooling fuel container 100(400) may surround only a part of the housing 38(384). Further, if the cooling fuel is stored within the cooling fuel storage chamber 102(402), the need to supply the cooling fuel towards the housing 38(384) may be low, and therefore, the cooling fuel may be simply supplied into the cooling fuel storage chamber 102(402).

Further, by configuring the fuel release holes 134 of the cooling fuel container 100 (see FIG. 5) such that the fuel can be released to the extent that the fuel does not overflow from the cooling fuel storage chamber 102, the fuel discharge holes 132 or the fuel discharge holes 433a of the fuel discharge pipe 433 can be omitted. Alternatively, by configuring the fuel discharge holes 132 or the fuel discharge holes 433a of the fuel discharge pipe 433 such that they can release the fuel that may overflow from the cooling fuel storage chamber 102, the fuel release holes 134 can be omitted. In addition, although the case body 83 and the cover 85 are made of resin in the above embodiments, at least one of them can be made of metal. Further, although the housing 38(384) is made of metal having an electrical conductivity in the above embodiment, the housing 38(384) may be made of electrically conductive resin. Furthermore, the housing 38(384) may have a resin housing body and an electrical conductive layer provided on the inner side and/or the outer side of the housing body.

Furthermore, although the cooling fuel piping 130 is attached to the set plate 60, which has the controller case 82, by the engaging or attaching mechanism 128, the controller case 82 may be disposed on the lower unit 18 and the cooling fuel piping 130 may be attached to the lower unit 18 by means of an engaging or attaching mechanism that is similar to the engaging mechanism 128 of the above embodiment. Alternatively, the cooling fuel piping 130 may be directly attached to the set plate 60 or the lower unit 18 by a suitable mechanism, such as screws or a clip or by a suitable method, such as crimping. Further, the controller case 82 may be disposed on one of the set plate 60 and the lower unit 18, and the cooling fuel piping 130 or the nozzle holder 18 may be attached to the other of the set plate 60 and the lower unit 18. It is possible to integrate the upper unit 17 and the lower unit 19 with each other. It is possible to omit the reservoir cup 20. The O-ring 104(404) may be replaced with a comparative seal member or may be omitted. The fuel pump 24, the pump controller 80 and the controller case 82 are the primary elements of the fuel supply system 10. The other elements except for the elements that are used for supplying the cooling fuel may be omitted.

This invention claims:

1. A fuel supply system comprising:
a fuel pump constructed to pump fuel from a fuel tank and to supply the fuel;
a pump controller constructed to control the fuel pump; and
a pump controller case constructed to receive the pump controller;
wherein the pump controller case includes a wall portion made of an electrically conductive material; and
wherein a portion of the fuel is directed to the wall portion of the pump controller case for cooling the wall portion.

2. The fuel supply system as in claim 1, wherein the portion of the fuel is at least one of a primary stream of fuel supplied to a target outside of the fuel tank, a flow of the fuel with vapor discharged from the fuel pump, and a flow of the fuel returned from a pressure regulator that adjusts the pressure of the fuel discharged from the fuel pump.

3. The fuel supply system as in claim 1, wherein the pump controller case is disposed on a fixed member, and a fuel supply piping for supplying the portion of the fuel is attached to the fixed member by an attaching member.

4. The fuel supply system as in claim 1, wherein the electrically conductive material is at least one of a resin and a metal.

5. The fuel supply system as in claim 1, wherein the pump controller case is positioned in a fuel container.

6. The fuel supply system as in claim 5, wherein the fuel container includes a nozzle configured to transfer the portion of the fuel.

7. The fuel supply system as in claim 5, wherein the fuel container defines holes configured to drain the portion of the fuel.

8. The fuel supply system as in claim 5, further including at least one sealing member, the sealing member positioned between the pump controller case and the fuel container.

9. The fuel supply system as in claim 8, wherein the sealing member is at least one of a scaling agent and an o-ring.

10. The fuel supply system as in claim 1, further including a ground terminal positioned between the pump controller case and a circuit board of the pump controller.

11. A fuel supply system comprising:
a fuel pump configured to pump fuel from a fuel tank;
a pump controller constructed to control the fuel pump;
a pump controller case, wherein the pump controller is positioned inside the pump controller case, further wherein the pump controller case includes a wall portion made of an electrically conductive material; and
a fuel container positioned adjacent the wall portion of the pump controller case and constructed to store a portion of the fuel.

12. The fuel supply system as in claim 11, wherein the portion of the fuel is discharged from the fuel container at a level higher than a level for supplying the portion of the fuel into the fuel container by a fuel supply device.

13. The fuel supply system as in claim 11, further comprising a fuel supply device configured to supply the portion of the fuel to an inner wall surface of the fuel container.

14. The fuel supply system as in claim 11, further comprising a fuel releasing device constructed to release the portion of the fuel from a lower portion of the fuel container.

15. The fuel supply system as in claim 11, wherein the portion of the fuel is at least one of a primary stream of fuel supplied to a target outside of the fuel tank, a flow of the fuel with vapor discharged from the fuel pump, and a flow of the fuel returned from a pressure regulator that adjusts the pressure of the fuel discharged from the fuel pump.

16. The fuel supply system as in claim 11, wherein the pump controller case is connected to a fixed member, and a fuel supply piping for supplying the portion of the fuel is attached to the fixed member by an attaching device.

17. A fuel supply system for supplying fuel stored within a fuel tank to a target outside of the fuel tank, comprising:
a fuel pump disposed within the fuel tank;
a pump controller constructed to control the operation of the fuel pump;
a pump controller case attached to the fuel tank, wherein the pump controller is disposed within the pump controller case;
a first fuel path extending from the fuel pump to the outside target,
a second fuel path extending from the fuel pump to the pump controller case, so that the pump controller case is cooled by the fuel.

18. The fuel supply system as in claim 17, wherein the second fuel path includes a fuel container disposed proximal to the pump controller case, so that the fuel flowing through the fuel container directly contacts the pump controller case.

19. The fuel supply system as in claim 17, wherein the fuel container includes a side wall and a bottom.

20. The fuel supply system as in claim 17, wherein the second fuel path further comprising a device for orienting the fuel within the fuel container towards the pump controller case, so that the fuel contacts the pump controller case.
